(19) United States
(12) Patent Application Publication
(10) Pub. No.: US 2023/0355359 A1
(43) Pub. Date: Nov. 9, 2023

(54) Abutment and Dental Implant System for Installing Dental Prosthetics

(71) Applicants: Arnaldo DiRezze, Shelby Twp, MI (US); Amando Doku, Warren, MI (US)

(72) Inventors: Arnaldo DiRezze, Shelby Twp, MI (US); Amando Doku, Warren, MI (US)

(21) Appl. No.: 17/757,618

(22) PCT Filed: Dec. 21, 2020
(86) PCT No.: PCT/US2020/066361

§ 371 Date: Jun. 17, 2022

Related U.S. Application Data
(60) Provisional application No. 62/950,384, filed on Dec. 19, 2019.

(51) Int. Cl. A61C 8/00; A61C 9/00

(52) U.S. Cl. CPC A61C 8/0056; A61C 9/0046; A61C 8/006

(57) ABSTRACT

An abutment for a dental implant system includes a main body extending along a longitudinal axis from a first end to a second end. The main body includes a peripheral side surface having a continuously-flared profile from the first end to the second end. The abutment further includes one or more impression features formed at the second end of the main body and one or more scan features formed at the second end of the main body. A clocking element is formed at the first end of the main body. The abutment includes a matte material surface and is configured for use as an impression transfer and as a scan body in a dental implant operation.

### CROSS REFERENCE TO RELATED APPLICATIONS

This application claims priority under 35 U.S.C. § 119(e) to U.S. Provisional Application 62/950,384, filed on Dec. 19, 2020. The disclosure of this prior application is considered part of the disclosure of this application and is hereby incorporated by reference in its entireties.

### TECHNICAL FIELD

This disclosure relates to healing abutments for use with dental prosthetics, and more particularly, to healing abutments configured to function as an impression transfer and a scan body for use in modeling an implant site.

### BACKGROUND

In a conventional method for providing dental prosthetics, such as crowns, an implant is inserted within the jaw of a patient and a cover screw (flat) or a healing abutment (raised) is attached to the implant. The healing abutment allows the gum tissue to heal around the abutment, thus creating somewhat of a form or ‘well’ of tissue above the implant through which the crown can be attached to the implant. Typically, the healing abutment is removed (unscrewed) from the implant site after several months of healing and an impression post (transfer post, impression coping, etc.) is temporarily attached to the implant. The impression post commonly has cuts, grooves, and/or shapes that allow the profile of post to be ‘transferred’ from the mouth back to the impression silicone accurately. The impression silicone is then used as a mold for forming a stone model of the mouth and the implant site. The healing abutment is then replaced into the implant in the mouth while a crown is fabricated at the lab using the model.

While this method is suitable, removal and replacement of the healing abutment may result in a space being formed between the transfer coping and the tissue. For example, upon removal of the healing abutment, the gum tissue around the implant site may slump slightly as the transfer coping—unless it is of the same shape as the healing abutment—does not support the tissue, even for a matter of minutes. During formation of the silicone mold, the fluid silicone material used to capture the detail of the transfer coping may flow into the three-dimensional space between the transfer coping and the gum tissue. As a result of the movement of the gum tissue around the implant site, the silicone mold may not accurately reflect the original shape of the tissue well. Accordingly, a fit between the final abutment and crown within the implant site may require further attention (e.g., lasering of the gums) from a dental professional to ensure proper fit.

### SUMMARY

The abutment of the present disclosure is configured to provide a stable, esthetic, functional, and cleansable tooth emergence from the gums at an implant site. The present disclosure aims to provide not just a product, but a system and method to enhance all implant outcomes. In addition to this, the present disclosure provides a solution for both traditional (impression/stone model) workflows as well as digital (optical scanner) workflows.

One aspect of the disclosure includes an abutment for a dental implant system. The abutment includes a main body extending along a longitudinal axis from a first end to a second end and including a peripheral side surface having a continuously-flared profile from the first end to the second end. The abutment also includes a clocking element formed at the first end of the main body. The abutment further includes at least one of (i) an impression feature and (ii) a scan feature formed at the second end of the main body.

This aspect of the disclosure may include one or more of the following optional features. In some examples, a portion of the main body including the scan feature is formed of a zirconia. Here, wherein the zirconia may be a pink zirconia.

In some implementations, the continuous flare is a progressive flare. Optionally, the progressive flare includes a first portion having a first flare rate adjacent to the first end of the main body and a second portion having a second flare rate adjacent to the second end of the main body. In some examples, the first flare rate is greater than the second flare rate. In some implementations, the first portion includes a curved surface and the second portion includes a straight surface. In some configurations, the continuous flare is a constant flare.

In some examples, the clocking element is hexagonal. In some implementations, the impression feature includes at least one of a flat surface, a notch, a protrusion, and a radial groove. In some examples, wherein the impression feature includes at least one of a flat surface, a notch, a protrusion, and a radial groove. Optionally, the impression feature and the scan feature are integrally formed with each other. In other examples, the impression feature and scan feature are separately formed from each other.

In some examples, the abutment includes a screw hole extending from the first end of the main body to the second end of the main body. In other examples, the abutment includes one or more markings disposed on the second end of the main body.

Another aspect of the disclosure provides a dental implant system including two or more of the abutments. A first abutment of the two or more of the abutment includes a first size and a second abutment includes of the two or more of the abutment includes a second size different from the first size. Optionally, the system further includes an implant having a size corresponding to a size of the abutment.

### DESCRIPTION OF DRAWINGS

FIG. 1 is an elevation view of a system including an abutment according to the principles of the present disclosure;

FIG. 2 is a plan view of the abutment of FIG. 1;

FIG. 3 is a plan view of an alternative example of an abutment according to the principles of the present disclosure;

FIG. 4 is an elevation view of an abutment according to the principles of the present disclosure;

FIG. 5 is a plan view of the abutment of FIG. 4;

FIG. 6 is an elevation view of an implant and crown assembly made according to the principles of the present disclosure;

FIG. 7 is an elevation view of an alternative example of an abutment according to the principles of the present disclosure;

FIG. 8 is a plan view of the abutment of FIG. 7;

FIG. 9 is an elevation view of an alternative example of an abutment according to the principles of the present disclosure;

FIG. 10 is a plan view of the abutment of FIG. 9; and

FIG. 11 is a table showing dimensions of examples of abutments according to the principles of the present disclosure.

Like reference symbols in the various drawings indicate like elements.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

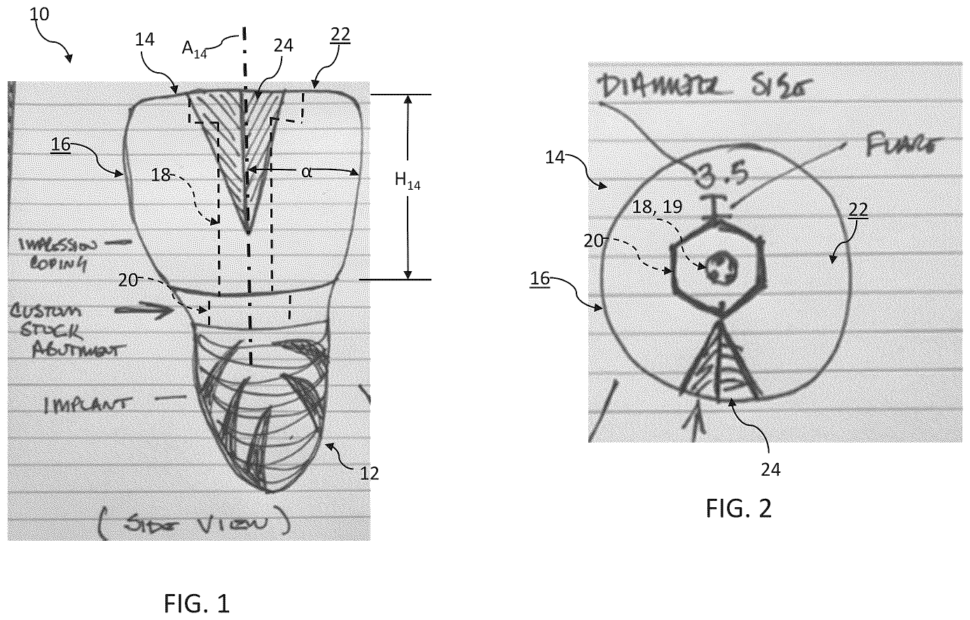

Referring to FIGS. 1-5, a system 10 according to the present disclosure is shown. The system 10 includes an implant 12 and an abutment 14. The implant 12 may be a typical implant 12, as is known in the art. The abutment 14 attaches to the implant 12 and is configured to function as each of a healing abutment, a transfer coping, and a scan body, as described in greater detail below.

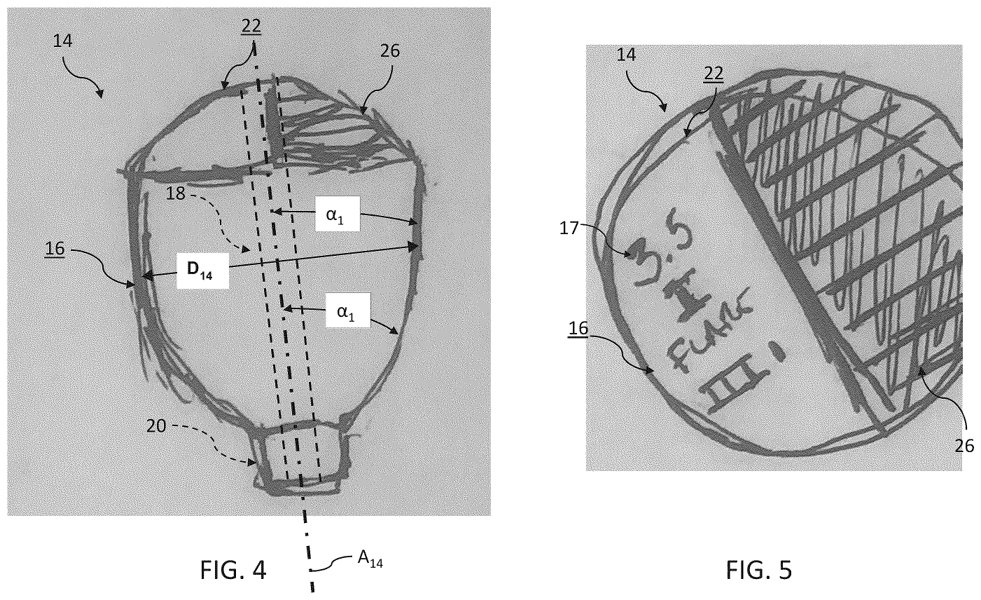

With reference to FIGS. 1 and 4, examples of an abutment 14 are shown. While multiple examples of an abutment 14 are illustrated for the sake of clarity, it will be appreciated that the features of any one or more of the examples may be incorporated into a single abutment 14. Accordingly, the features of the examples of the examples abutment 14 will be collectively described herein. The abutment 14 is made of a non-reflective pink zirconia to mimic the color of the gums and to allow the abutment 14 to function as a scan body, as discussed in greater detail below.

As best shown in FIGS. 1 and 4, the abutment 14 includes a peripheral side surface 16 that extends from a first end (e.g., bottom) of the abutment 14 to a second end (e.g., top) of the abutment 14. The peripheral side surface 16 defines a flared portion of the abutment 14 extending continuously from the first end to the second end. The profile of the flared portion is selected to correspond to different areas of the mouth. For example, a first flare profile may be used for the front teeth, a second flare profile may be used for the pre molars or ‘middle’ teeth, and a third profile may be used for the molars.

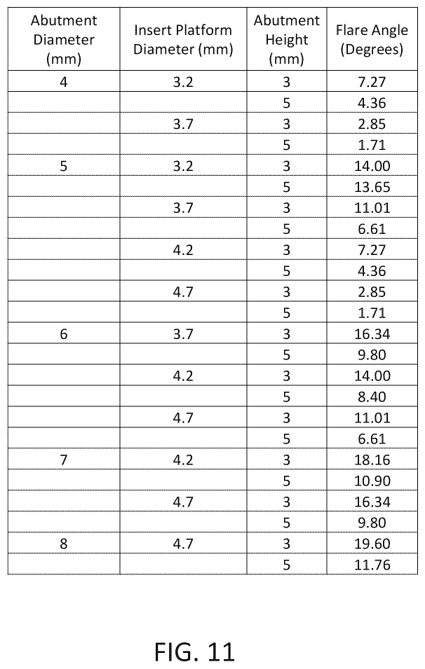

In some examples, such as in FIG. 1, the abutment 14 may have a constant or substantially constant flare profile, whereby a diameter D₁₄ of the abutment 14 increases at a constant rate from the bottom to the top, giving the abutment 14 a substantially conical shape. For example, the peripheral side surface 16 may be formed at an angle α ranging from 5 degrees to 15 degrees relative to the longitudinal axis A₁₄ of the abutment, as indicated in FIG. 1. The flare rate for each abutment will correspond to an angle α that provides a constant taper between a diameter of a platform (e.g., top surface) of the implant 12 and the diameter of the top surface 22 of the abutment 14. For example, where an abutment 14 has a height of 3 mm, a top-surface diameter of 5 mm, and is attached to an insert having a platform diameter of 3.2 mm, the flare angle would be 16.7 degrees (tan⁻¹ ((2.5 mm radius−1.6 mm radius)/3 mm height)). FIG. 11 provides a table showing potential flare angles for different abutment and insert combinations.

In the illustrated example, the flare profile of the peripheral side surface 16 is progressive, whereby the abutment 14 has a greater flare rate (i.e., change in diameter relative to length) at the bottom of the abutment 14 than at the top of the abutment 14. Put another way, the diameter of the abutment 14 increases at a greater rate along a longitudinal axis A₁₄ of the abutment 14 at the bottom of the abutment 14 than at the top of the abutment 14, such that a lower portion of the peripheral side surface is convex (e.g., hemispherical) and an upper portion of the peripheral side surface is straight (e.g., conical). As shown in FIG. 4, the progressive flare results in peripheral side surface 16 the lower portion of the abutment 14 being formed at a greater angle α₁ relative to the longitudinal axis A₁₄ of the abutment 14 than the angle α₂ of the upper portion of the peripheral side surface 16. In other words, the lower portion of the abutment 14 flares (i.e., increases in diameter along longitudinal direction) at a greater rate than the upper portion of the abutment 14.

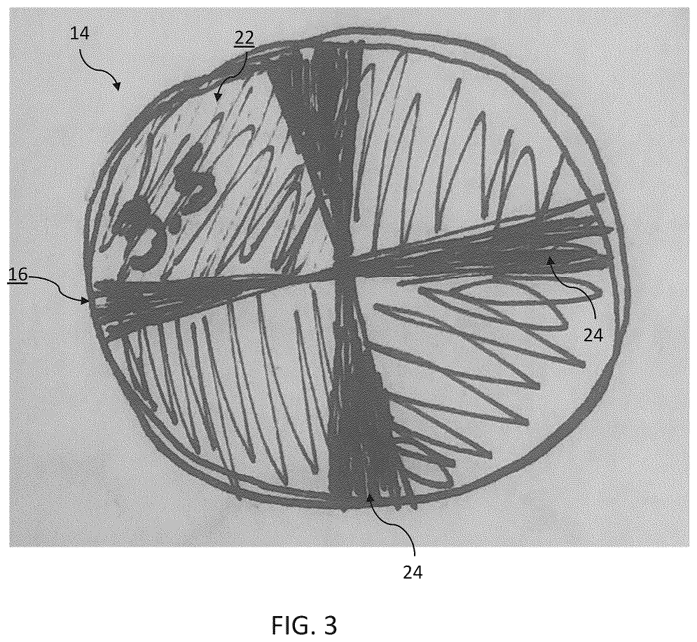

As shown in FIGS. 2 and 4, the tops of the abutments 14 include markings 17 for identifying both a size (e.g., diameter) of the underlying implant 12, as well as the flare profile of the abutment 14. Denoting the size and flare profile of the abutment 14 allows identically flared parts to be selected and used in subsequent steps. The markings 17 may be engraved markings 17 formed in the top surface 22 of the abutment 14. In other examples, the markings 17 may be printed markings applied to the top surface 22 of the abutment 14.

Referring again to FIGS. 1 and 2, the abutment 14 includes a center access screw hole 18, which receives a fastener 19, commonly referred to as a fixation screw, for attaching the abutment 14 to the implant 12. The fastener 19 may be embodied as a screw, such as a standard implant fixation screw corresponding to the thread type of the implant used. Optionally, plastic pieces may be incorporated within the screw hole 18 that deform under sterilization so that the abutments 14 cannot be reused after sterilization. For example, the screw hole 18 may include a plastic bushing or insert that is initially formed with internal threads matching the threads of the screw hole 18. When sterilized, the plastic material of the bushing may deform within the screw hole 18, thereby preventing the abutment 14 from being reused.

Referring to FIG. 4, the abutment 14 further includes a clocking element 20, such as external hex or lobe feature. The clocking element is configured to interlock with the corresponding implant 12 to fix a rotational position of the abutment 14 relative to the implant 12. The clocking element 20 may be made out of metal or other materials having a greater hardness than the upper portion of the abutment 14 to maximize durability of the interface between the clocking element 20 and the abutment 14.

As provided above, the abutment 14 is configured to function as an impression transfer in what is typically referred to as an analog workflow, where a physical mold is made of the mouth for creating the crown. As an impression transfer, the main function of the abutment 14 is to ‘jump’ or communicate the location, angulation, and rotation of an implant so that the laboratory can replicate the configuration of the implant on a stone model in order to make a crown. The two desirable features of the abutment 14, when functioning as a transfer coping are: (1) the ability to be put back into a silicone impression after the silicone is removed from the mouth and ‘plugging’ the abutment 14 (the same abutment 14 or an identical one) back into the silicone impression so that there is no wiggling, movement, or any doubt of a snap or suction fit, and (2) the ability to withstand the hydraulic force or any other dislodging force of dental plaster or stone being poured into the silicone impression. Any movement, vibration, tipping, torqueing of the abutment/analog pair while stone is being poured could lead to an undesirable fit of the system 10 in the mouth. Accordingly, the height of the abutment 14 is selected to be high enough to be embedded in the silicone impression mold to such a depth as to not move when stone is subsequently being poured into the silicone mold.

To aid in obtaining and maintaining proper orientation of the abutment relative to the silicone mold during casting of the stone mold, the top surface 22 of the abutment 14 is formed with impression features 24 (e.g., surface flats, cut outs, protrusions, radially-extending grooves). Since the clocking element 20 is locked into the implant 12, an exact copy or replica of the rotational position of the abutment 14 represents the same exact rotational position and angulation of the implant 12 in the silicone mold. The impression features 24 will be pronounced enough (e.g., depth, width, profile) so that there will be a definite feeling or proprioceptive positive check to ensure the top of the abutment 14 is locked into place within the molded impression of the silicone mold. While the impression features 24 of the illustrated examples are embodied as recesses, other features, such as protrusions, may be utilized to communicate a relative orientation between the implant 12 and the silicone mold via the abutment 14.

In one example of an analog workflow including the abutment 14, a practitioner may place a 4.5 diameter×10 mm long dental implant in a molar dental site. The practitioner then selects an abutment having a flare profile corresponding to the implant site, such as a ‘size 6’ flare profile. The practitioner may then record the size/type of the abutment 14 for use in other steps of the workflow. While the abutment information may be recorded manually, in some examples a mobile software application may be used to take a picture of the abutment, to scan an identifier (e.g., barcode, QR code) or marking 17 associated with the abutment 14, or to enter identification information for the abutment 14. This functions for logging purposes as well as e-retail purposes, such that the practitioner can purchase the future parts corresponding to the abutment 14 using the mobile software application.

After a healing period of approximately four to five months after installation of the implant 12 and abutment 14, a silicone impression is made of the mouth cavity including the abutment 14, making sure to capture the flared abutment 14 and the adjacent and opposing teeth. The practitioner then fills out a lab script instructing the lab to fabricate a molar crown based on the implant brand, implant diameter (e.g., 4.5), and flare size (e.g., 6).

Using the information provided in the lab script, the lab selects the same size and type of abutment 14 and inserts it into the corresponding impression of the silicone mold, utilizing the impression features 24 of the abutment 14 to positively seat it back into the impression of the silicone mold. Here, an analog (a metal part that represents the implant in the mouth) is attached to the bottom of the abutment 14, such that when the top of the abutment 14 is inserted into the impression, the bottom of the abutment 14 and the analog will protrude from the silicone mold. The protruding portion of the analog represents the orientation of the corresponding implant 12 that remains within the mandible of the patient.

With the abutment 14 and analog situated in the impression of the silicone mold, a stone model is poured into the silicone mold. Here, the stone encapsulates the analog such that the analog serves as a representative of the orientation of the implant 12 and abutment 14 within the mouth. Once the stone mold dries and is separated, the stone mold represents the ‘working model’— a model that accurately shows the position and orientation of the implant 12 within the mouth. Importantly, the stone model also shows how the soft tissue surrounding the implant 12 has healed or formed around the abutment 14.

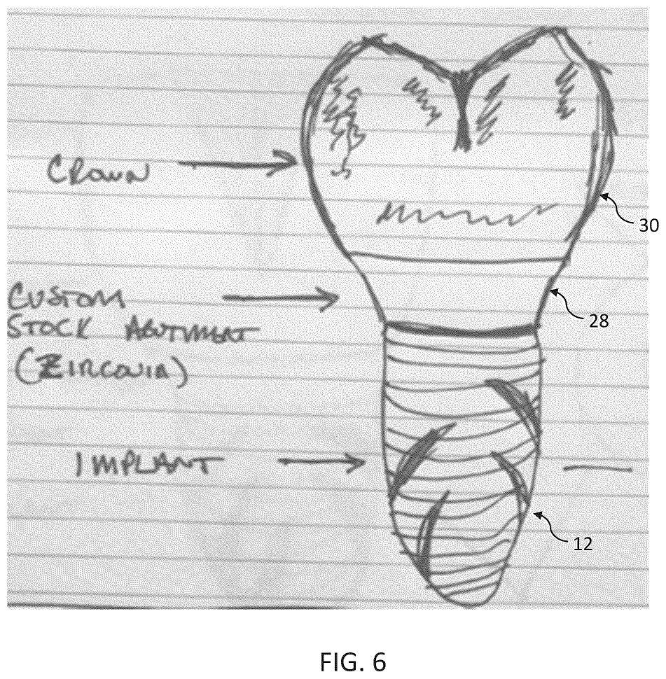

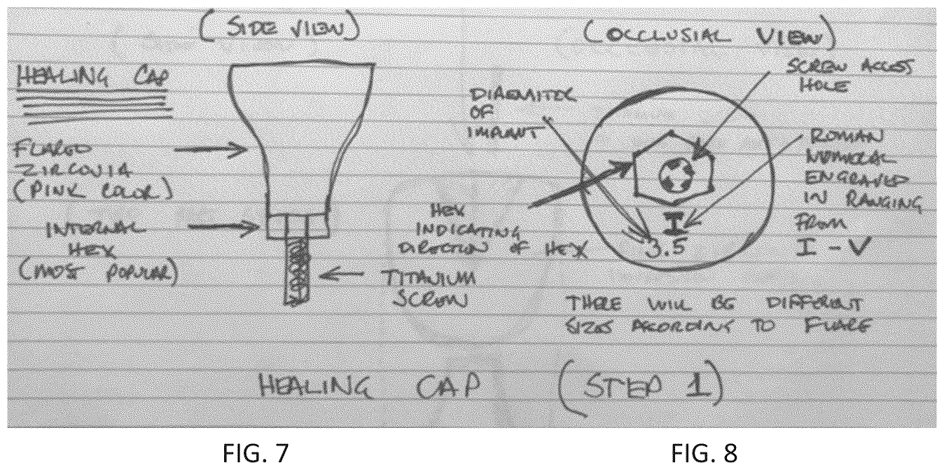

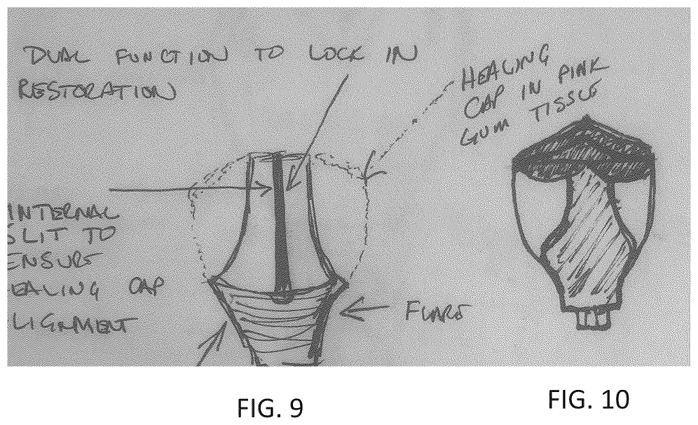

With the analog fixed within the stone model, the abutment 14 is detached from the analog to expose a model of the tissue well within the stone mold. When looking down into the modeled tissue well, the platform (internal hex) of the implant (represented by the analog) will be visible. Based on the model of the tissue well, a final abutment 28 (FIG. 6) is chosen as the base of the new crown 30. The final abutment 28 can be a stock or preformed abutment, a custom abutment that can be altered, or a titanium-based abutment that can be milled. Regardless of the final abutment 28 type chosen, the flare profile of the final abutment 28 is the exact same as the flare profile of the abutment 14 to ensure a linear workflow. Based on the model tissue well and the final abutment 28, a crown 30 is fabricated on the chosen final abutment 28 type utilizing the same flare or emergence from the gums as the abutment 14.

In addition to being configured for use as a transfer coping in an analog workflow, the abutment 14 is also operable as a scan body 14 for use in a digital workflow. Accordingly, the abutment may include additional design features that can be identified by an optical scanner and are distinguishable enough from other size flares. In one example, the top surface 22 of the abutment 14 includes one or more scan features 26, such as standard flats and/or cutouts, which are cataloged in an electronic library. Here, a technician can access the library to select a digital model of the abutment 14, allowing the technician to drag and drop an abutment/implant combination, virtually, into design software, thus recreating the proper angulation, rotation, and position of the implant.

The scan features 26 are configured to be wide enough, deep enough, and provide enough contrast to a camera that by lining up just a small portion of the abutment 14 that sticks above the gums with a corresponding profile in the design library, the exact spatial information of the system 10 can be accurately determined. The scan features 26 may have a predetermined pattern corresponding to each diameter and flare angle combination. Optionally, the scan features 26 may be the same as (i.e., integrally formed with) the impression features 24. For example, the scan features 26 and the impression features 24 may both be configured as one or more distinct impressions or protrusions that can be recognized both within a physical mold and by digital scanners. Alternatively, the top surface may be labeled with markings 17 identifying the size and flare angle, as discussed above.

Once the abutment 14 is identified, a digital version of the implant system 10 may be selected from the corresponding digital library depicting the abutment 14 and implant 12 together. The digital version of the system 10 can then be incorporated into the digital image of the mouth taken by the practitioner to fabricate a digital model for crown design.

In a digital environment, the top and sides of the abutment 14 are digitally scanned, as well as the adjacent teeth and opposing teeth. The digital scan is then sent to a lab where technicians, knowing the diameter and the flare size used, will select the corresponding digital model of the implant from a database. The digital model of the implant 12 is then incorporated into the optical scan taken of the mouth of the patient. At this point, the two images, the one from the optical scan and the one from the database will be stitched and meshed together using similar data points (e.g., the scan features 26). This provides the lab technician with a working model or ‘master’ model, but on the computer, not in stone. Similar to the analog workflow, a final abutment 28 can then be selected or milled, and a crown 30 can be fabricated based on the digital model, keeping the same flare profile as the abutment 14.

The abutment 14 of the present disclosure can be placed either at the time of surgery, which would be the most ideal for healing, or at a time immediately preceding the final impression or scan—whichever the practitioner prefers (any components attached to the implant could theoretically be hit with food, chewed on, or traumatized leading to micro vibrations as the implant is healing and ultimate failure). Some practitioners may bury the implant 12 within the gum tissue until the time that a final impression/scan is made. The abutment 14 may be single use, or single patient use.

A number of implementations have been described. Nevertheless, it will be understood that various modifications may be made without departing from the spirit and scope of the disclosure. Accordingly, other implementations are within the scope of the following claims.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

1. An abutment for a dental implant system, the abutment comprising;
a main body extending along a longitudinal axis from a first end to a second end and including a peripheral side surface having a continuously-flared profile from the first end to the second end;
a clocking element formed at the first end of the main body; and
at least one of (i) an impression feature and (ii) a scan feature formed at the second end of the main body.

2. The abutment of claim 1, wherein at least a portion of the main body including the scan features is formed of a zirconia.

3. The abutment of claim 2, wherein the zirconia is a pink zirconia.

4. The abutment of claim 1, wherein the continuous flare is a progressive flare.

5. The abutment of claim 4, wherein the progressive flare includes a first portion having a first flare rate adjacent to the first end of the main body and a second portion having a second flare rate adjacent to the second end of the main body.

6. The abutment of claim 5, wherein the first flare rate is greater than the second flare rate.

7. The abutment of claim 4, wherein the first portion includes a curved surface and the second portion includes a straight surface.

8. The abutment of claim 1, wherein the continuous flare is a constant flare.

9. The abutment of claim 1, wherein the clocking element is hexagonal.

10. The abutment of claim 1, wherein the impression feature includes at least one of a flat surface, a notch, a protrusion, and a radial groove.

11. The abutment of claim 1, wherein the impression feature includes at least one of a flat surface, a notch, a protrusion, and a radial groove.

12. The abutment of claim 1, wherein the impression feature and the scan feature are integrally formed with each other.

13. The abutment of claim 1, wherein the impression feature and the scan feature are separately formed from each other.

14. The abutment of claim 1, further comprising a screw hole extending from the first end of the main body to the second end of the main body.

15. The abutment of claim 1, further comprising one or more markings disposed on the second end of the main body.

16. A dental implant system comprising two or more of the abutment of claim 1, a first abutment of the two or more of the abutment includes a first size and a second abutment includes of the two or more of the abutment includes a second size different from the first size.

17. The system of claim 13, further comprising an implant having a size corresponding to a size of the abutment.
